(19) United States
(12) Patent Application Publication
(10) Pub. No.: US 2014/0089709 A1
(43) Pub. Date: Mar. 27, 2014

(54) INFORMATION PROCESSING APPARATUS AND INFORMATION PROCESSING METHOD

(71) Applicant: Kabushiki Kaisha Toshiba, Tokyo (JP)

(72) Inventors: Taisuke Furuya, Hamura-shi (JP); Yasuyuki Mizuura, Tokyo (JP)

(21) Appl. No.: 13/933,363

(22) Filed: Jul. 2, 2013

(30) Foreign Application Priority Data
Sep. 27, 2012 (JP) 2012-214565

(51) Int. Cl. G06F 1/32

(52) U.S. Cl. CPC G06F 1/3234
USPC 713/323

(57) ABSTRACT

According to one embodiment, an information processing apparatus includes an operation control module, a calculator, and a display processor. The operation control module is configured to set the information processing apparatus in a power-saving state, based on a power-saving setup value corresponding to at least one power-saving setup item. The power-saving setup value is set by a user. The calculator is configured to calculate a total score indicative of a degree by which the power-saving state contributes to power saving during a period from a score calculation start time point to a reference time point. The display processor is configured to display an image associated with the total score.

### CROSS-REFERENCE TO RELATED APPLICATIONS

This application is based upon and claims the benefit of priority from Japanese Patent Application No. 2012-214565, filed Sep. 27, 2012, the entire contents of which are incorporated herein by reference.

### FIELD

Embodiments described herein relate generally to a technique for power saving.

### BACKGROUND

In recent years, various information processing apparatuses, such as a personal computer (PC) and a tablet, have been developed. Most of such information processing apparatuses have a power-saving function. The power-saving function is a function for setting up an operational environment which affects the amount of power that is consumed by the system, and, in some cases, the power-saving function is called “power management function”. By executing power-saving setup for some power-saving setup items in the PC, the user can reduce the power consumption of the PC.

Recently, attention has been paid to the power-saving function of the PC, from the standpoint of energy saving. If the power-saving functions of PCs in homes and PCs in companies are properly utilized, it is possible that a great deal of power can be saved, with a contribution to power-saving (ecology).

In addition, recently, techniques have begun to be developed for presenting to a user an index indicative of a degree by which present instantaneous power-saving setup values contribute to power saving.

However, even if a PC is temporarily set in a power-saving state, it is difficult to contribute to power saving (ecology). The reason is that the power consumption of the PC depends on sequential day-by-day states of use of the PC. Thus, it is necessary to realize a novel function for encouraging the user to continuously use the PC in the power-saving state.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an information processing apparatus according to an embodiment.

FIG. 2 is an exemplary block diagram illustrating the system configuration of the information processing apparatus of the embodiment.

FIG. 3 is a view for explaining some examples of power-saving setup items which are supported by a power-saving utility program of the information processing apparatus of the embodiment.

FIG. 4 is an exemplary view illustrating a contribution degree screen which is displayed by the power-saving utility program of the information processing apparatus of the embodiment.

FIG. 5 is an exemplary view for explaining a contribution degree image area in the contribution degree screen of FIG. 4.

FIG. 6 is an exemplary view illustrating some of a plurality of contribution degree images which are displayed in the contribution degree image area of the contribution degree screen of FIG. 4.

FIG. 7 is an exemplary view illustrating the other contribution degree images which are displayed in the contribution degree image area of the contribution degree screen of FIG. 4.

FIG. 8 is an exemplary view illustrating the relationship between the number of metals and a total score, which are displayed in the contribution degree image area of the contribution degree screen of FIG. 4.

FIG. 9 is an exemplary view for explaining a reference date change area in the contribution degree screen of FIG. 4.

FIG. 10 is an exemplary view illustrating a contribution degree screen which is displayed when the reference date was changed to a past date.

FIG. 11 is an exemplary view illustrating a contribution degree screen which is displayed when the reference date was changed to another past date.

FIG. 12 is an exemplary block diagram illustrating a configuration of a power-saving utility program of the information processing apparatus of the embodiment.

FIG. 13 is an exemplary flow chart illustrating the procedure of a contribution degree screen display process which is executed by the information processing apparatus of the embodiment.

### DETAILED DESCRIPTION

Various embodiments will be described hereinafter with reference to the accompanying drawings.

In general, according to one embodiment, an information processing apparatus includes an operation control module, a calculator, and a display processor. The operation control module is configured to set the information processing apparatus in a power-saving state, based on a power-saving setup value corresponding to at least one power-saving setup item. The power-saving setup value is set by a user. The calculator is configured to calculate a total score indicative of a degree by which the power-saving state contributes to power saving during a period from a score calculation start time point to a reference time point. The display processor is configured to display an image associated with the total score.

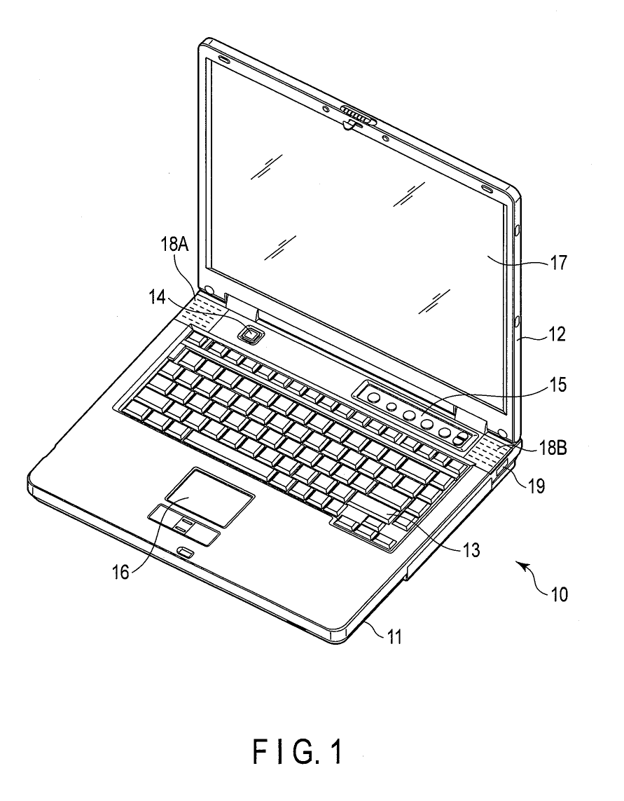

FIG. 1 is a perspective view showing the external appearance of an information processing apparatus according to an embodiment. This information processing apparatus is an electronic apparatus such as a personal computer (PC), a PDA, a tablet, a smartphone, or a TV. In the description below, the case is assumed that the information processing apparatus is realized as a notebook-type personal computer 10.

As shown in FIG. 1, the computer 10 is composed of a computer main body 11 and a display unit 12. An LCD (liquid crystal display) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered with the display unit 12.

The computer main body 11 has a thin box-shaped housing. A keyboard 13, a power button 14 for powering on/off the computer 10, an input operation panel 15, a pointing device 16 such as a touch pad, and speakers 18A and 18B are disposed on the top surface of the housing of the computer main body 11. Various operation buttons are provided on the input operation panel 15.

The right side surface of the computer main body 11 is provided with a USB (universal serial bus) connector 19. Various peripheral devices can be connected to the USB connector 19. An external display connection terminal (not shown), which supports, e.g. the HDMI (high-definition multimedia interface) standard, is provided on the rear surface of the computer main body 11. The external display connection terminal is used to output a digital video signal to an external display.

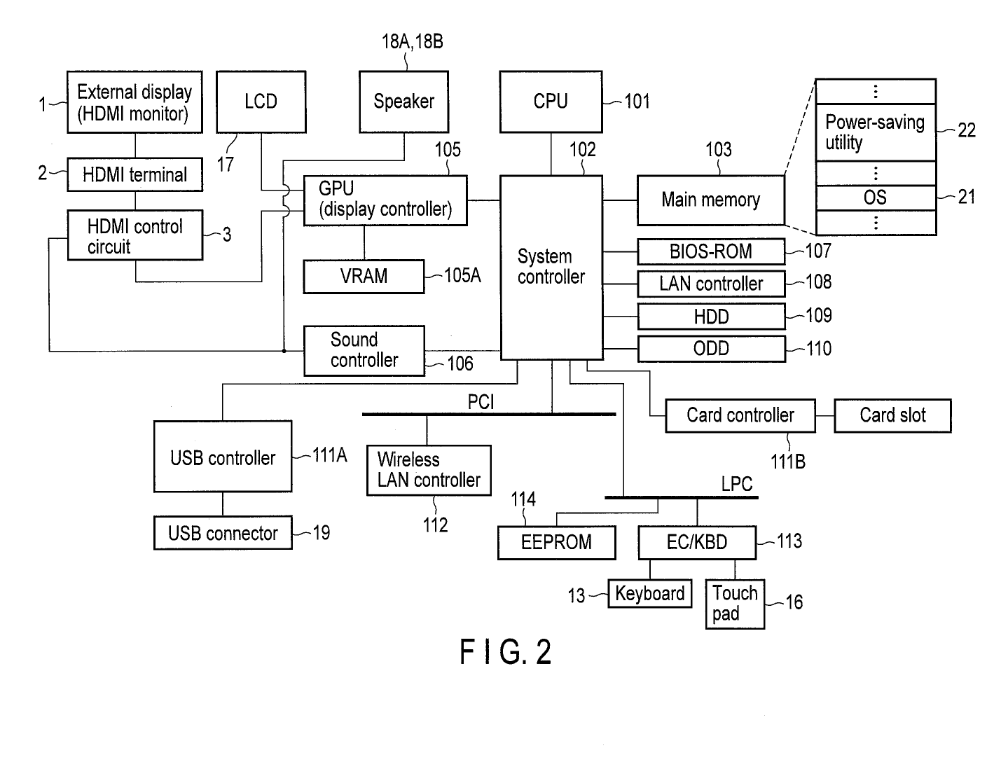

FIG. 2 is a view illustrating the system configuration of the computer 10.

The computer 10, as shown in FIG. 2, includes a CPU 101, a system controller 102, a main memory 103, graphics processing unit (GPU) 105, a video RAM (VRAM) 105A, a sound controller 106, a BIOS-ROM 107, a LAN controller 108, a hard disk drive (HDD) 109, an optical disc drive (ODD) 110, a USB controller 111A, a card controller 111B, a wireless LAN controller 112, an embedded controller/keyboard controller (EC/KBC) 113, and an EEPROM 114.

The CPU 101 is a processor for controlling the operations of the respective components in the computer 10. The CPU 101 executes an operating system (OS) 21, various utility programs and various application programs, which are loaded from the HDD 109 into the main memory 103. The utility programs include a power-saving utility program 22.

The power-saving utility program 22 is a program for setting values of power-saving setup items in power-saving setup information in accordance with a user operation, and setting the computer 10 in a power-saving state, based on the setup values of the respective power-saving setup items. The power-saving setup information includes, as the above-described power-saving setup items, a plurality of setup items relating to the operation of the computer 10, which affects the amount of power consumed by the computer 10.

Besides, the CPU 101 executes a BIOS which is stored in the BIOS-ROM 107. The BIOS is a program for hardware control.

The system controller 102 is a bridge device which connects a local bus of the CPU 101 and the respective components. The system controller 102 includes a memory controller which access-controls the main memory 103. The system controller 102 also has a function of communicating with the GPU 105 via, e.g. a PCI EXPRESS serial bus.

The GPU 105 is a display controller which controls the LCD 17 that is used as a display monitor of the computer 10. A display signal, which is generated by the GPU 105, is sent to the LCD 17. In addition, the GPU 105 can send a digital video signal to an external display 1 via an HDMI control circuit 3 and an HDMI terminal 2.

The HDMI terminal 2 is the above-described external display connection terminal. The HDMI terminal 2 is capable of sending a non-compressed digital video signal and a digital audio signal to the external display 1, such as a TV, via a single cable. The HDMI control circuit 3 is an interface for sending a digital video signal to the external display 1, which is called “HDMI monitor”, via the HDMI terminal 2.

The system controller 102 controls devices on a PCI (Peripheral Component Interconnect) bus and devices on an LPC (Low Pin Count) bus. The system controller 102 includes an IDE (Integrated Drive Electronics) controller for controlling the HDD 109 and ODD 110. The system controller 102 also has a function of communicating with the sound controller 106.

The sound controller 106 is a sound source device and outputs audio data, which is a playback target, to the speakers 18A and 18B or the HDMI control circuit 3. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11 standard. The USB controller 111A communicates with an external device which is connected via the USB connector 19. The card controller 111B executes data write and data read in/from a memory card which is inserted in a card slot provided in the computer main body 11.

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

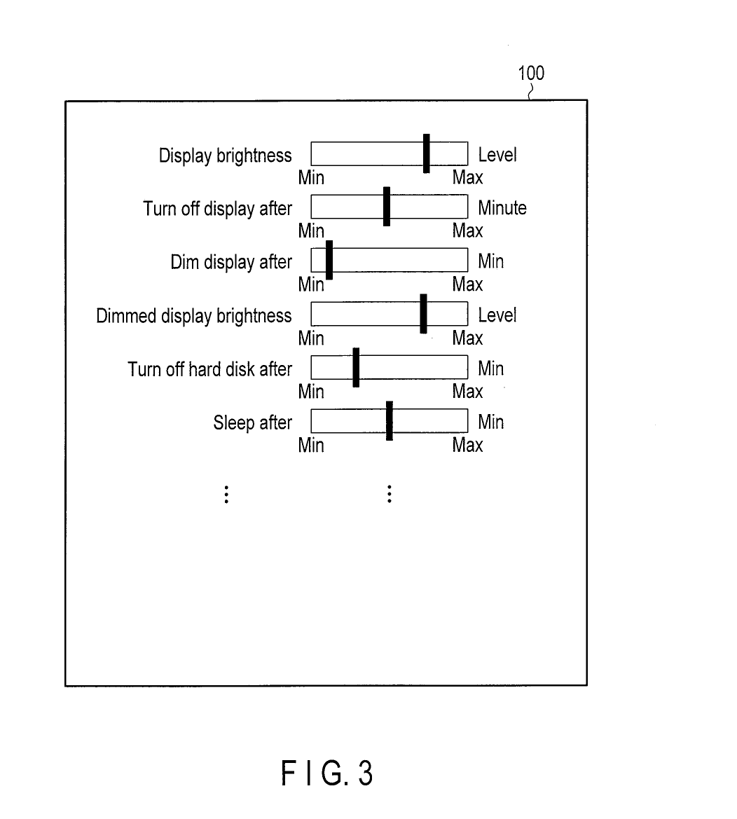

FIG. 3 illustrates examples of power-saving setup items which are supported by the power-saving utility program 22. In FIG. 3, reference numeral 100 denotes a power-saving setup screen. The power-saving setup screen 100 is a GUI which is displayed on the screen of the LCD 17 by the power-saving utility program 22. Using the power-saving setup screen 100, the user can set values of the respective power-saving setup items. The respective power-saving setup items, which are supported by the power-saving utility program 22, are used for setting up the operational environment of the computer 10, which affects the amount of power consumed by the computer 10. The power-saving setup items include, for instance, the following setup items.

The brightness of the screen (display brightness): This power-saving setup item is used for controlling the brightness of the display screen. The range of adjustment of the brightness (luminance) of the display screen is, for example, from level 1 (darkest) to level 100 (brightest).

The time until turn-off of the display (turn off display after): This power-saving setup item is used for executing control to turn off power of the display at an idle time. In this setup item, a time period from when the system is set in the idle state to when the power of the display is turned off is set.

The time until dimming of the screen (dim display after): This power-saving setup item is used for executing control to dim (darken) the display at an idle time. In this setup item, a time period from when the system is set in the idle state to when the display is dimmed is set.

The brightness of the screen at a time of dimming (dimmed display brightness): This power-saving setup item is used for controlling the brightness of the display screen at a time of dimming of the screen.

The time until turn-off of the HDD (turn off hard disk after): This power-saving setup item is used for executing control to turn off power of the HDD at an idle time. In this setup item, a time period from when the system is set in the idle state to when the power to the HDD is turned off is set.

The time until sleep (sleep after): This power-saving setup item is used for executing control to transition the system to a sleep state (standby state) at an idle time. In this setup item, a time period from when the system is set in the idle state to when the system is transitioned to the sleep state is set.

The power-saving utility program 22 can set the computer 10 in the power-saving state, based on the power-saving setup values corresponding to the respective power-saving setup items which are set by the user. Further, the power-saving utility program 22 includes a function of calculating a total score which indicates a degree by which the power-saving state of the computer 10 has contributed to power saving during a time period from a score calculation start time point to a reference time point. The score calculation start time point is, for example, a date when the use of the power-saving utility program 22 was started by the user. This date of start of use means the date on which score calculation was started by the power-saving utility program 22, that is, the start of score calculation. The reference time point is a time point which specifies the end of the time period that is a target period for calculating the total score. As the reference time point, for example, the present date is used. The power-saving utility program 22 can calculate, for example, on a day-by-day basis, a score (day score) indicative of the degree of contribution to power saving in each day, based on the contents of the power-saving setup used in this day. Then, the power-saving utility program 22 can calculate the above-described total score by totaling the scores (day scores) corresponding to the days belonging to the period from the score calculation start date to the reference date (present date).

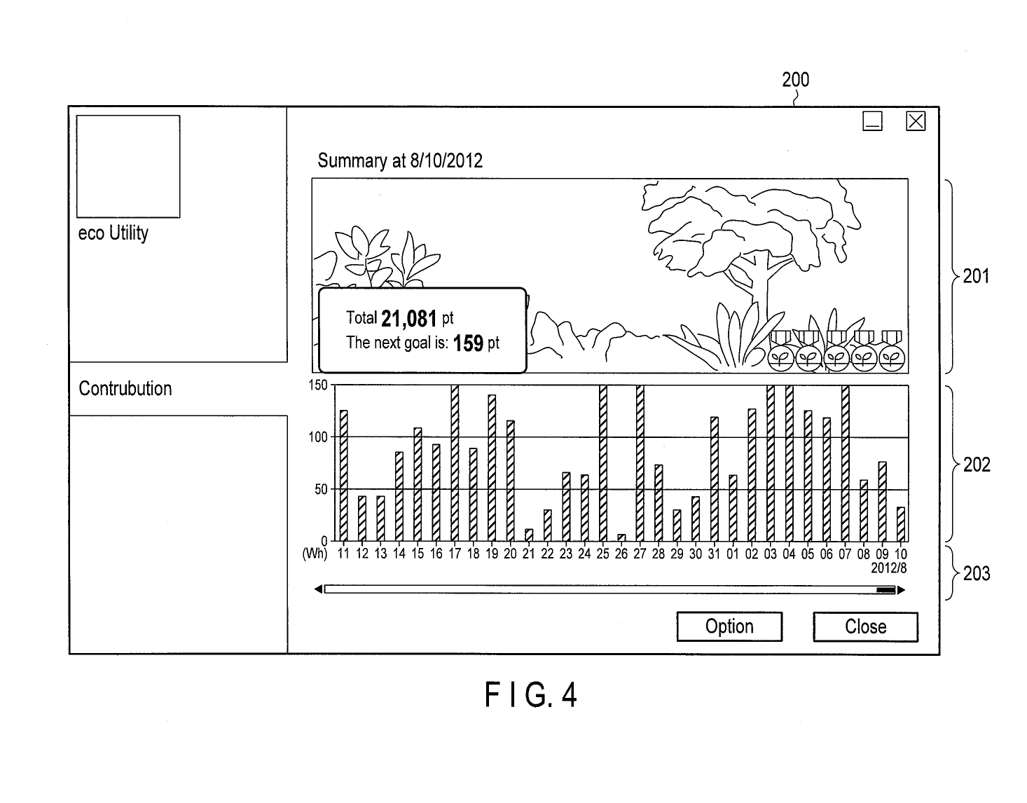

FIG. 4 illustrates a contribution degree screen 200 which is displayed on the screen of the LCD 17 by the power-saving utility program 22. The contribution degree screen 200 is a screen for easily understandably presenting to the user the contribution degree of the power-saving setup to power saving (ecology).

The contribution degree screen 200 includes a contribution degree image area 201, a graph area 202 and a reference date change area 203. The contribution degree image area 201 is a display area for displaying a total score from the score calculation start date to the reference date, and an image (contribution degree image) which is associated with the total score. The date at the right end of the reference date change area 203 indicates the reference date (present date). By moving a slider of the reference date change area 203, the user can change the reference date to an arbitrary past date. The graph area 202 displays a graph representing power consumption amounts of respective days belonging to the period from the score calculation start date to the reference date.

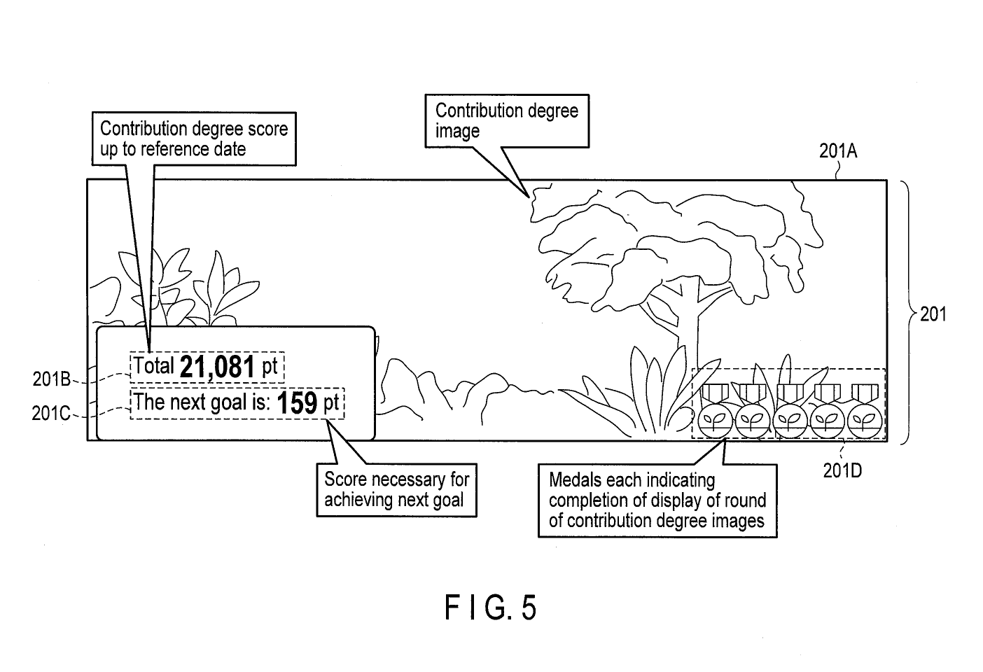

FIG. 5 illustrates the contents of the contribution degree image area 201 in greater detail. As shown in FIG. 5, the contribution degree image area 201 includes a contribution degree image display area 201A, a total score display area 201B, a next goal display area 201C, and a medal display area 201D.

The contribution degree image display area 201A displays an image (contribution degree image) which is associated with the total score from the score calculation start date to the reference date. The total score display area 201B displays the total score from the score calculation start date to the reference date. The next goal display area 201C displays a residual score necessary for achieving the goal.

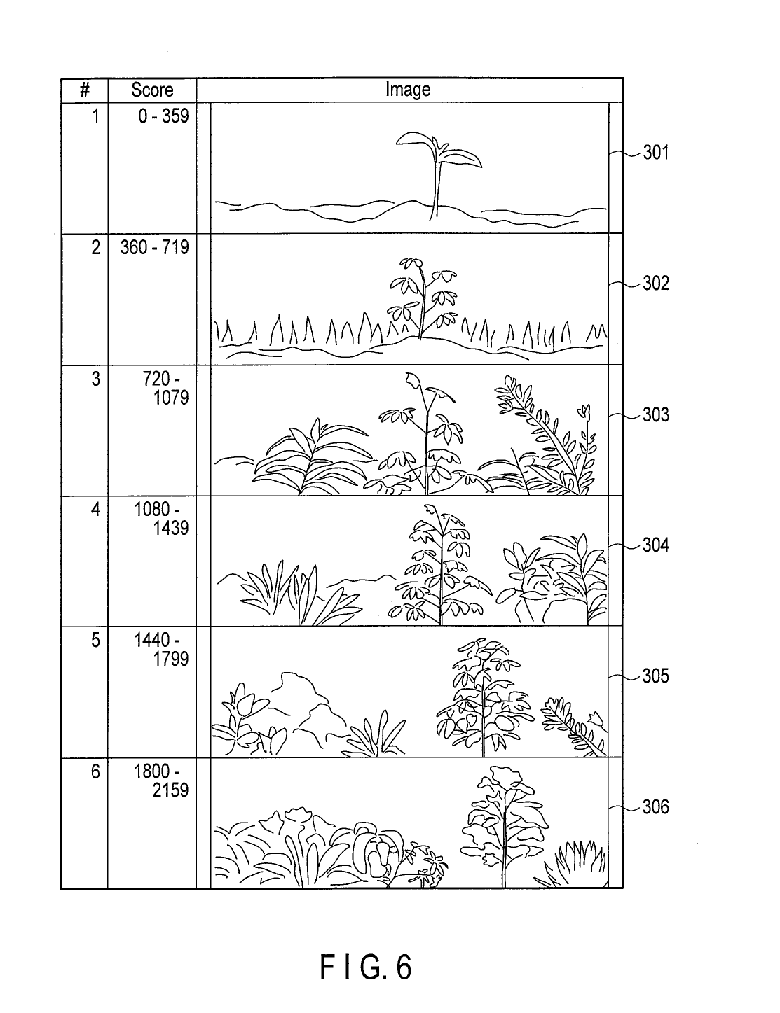

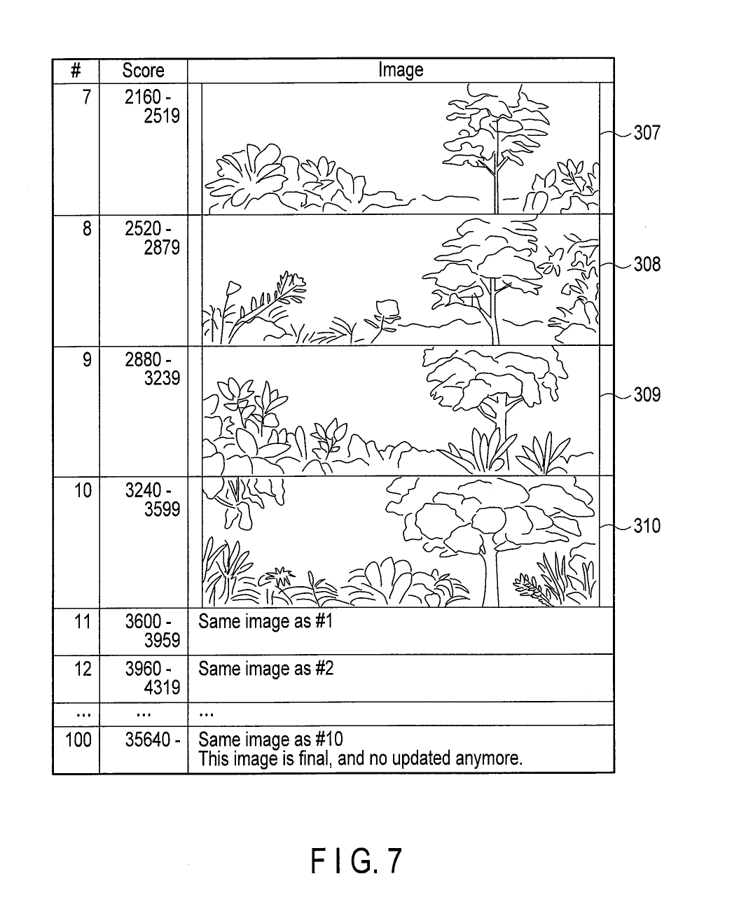

The power-saving utility program 22 changes the contribution degree image that is to be displayed, each time the total score reaches any one of a plurality of thresholds. The next goal display area 201C displays a residual score which remains before the present total score reaches the next threshold which is closest to the present total score. The contribution degree image, which is displayed in the contribution degree image display area 201A, is changed to a contribution degree image by which the user can better perceive power saving as the total score becomes higher. In the present embodiment, the power-saving utility program 22 changes the contribution degree image, which is to be displayed, among a plurality of contribution degree images, for example, ten contribution degree images with different degrees of growth of a plant, so that a contribution degree image, by which growth of the plant is more perceivable as the total score becomes higher, may be displayed. In this case, the process of growth of the plant can be presented to the user at ten levels. A contribution degree image of the first level is displayed in the initial state, and a contribution degree image of the tenth level transitions back to the contribution degree image of the first level. FIG. 6 and FIG. 7 illustrate the relationship between total scores and contribution degree images. As is understood from FIG. 6 and FIG. 7, ten contribution degree images 301 to 310 are successively used in turn in accordance with the increase of the total score.

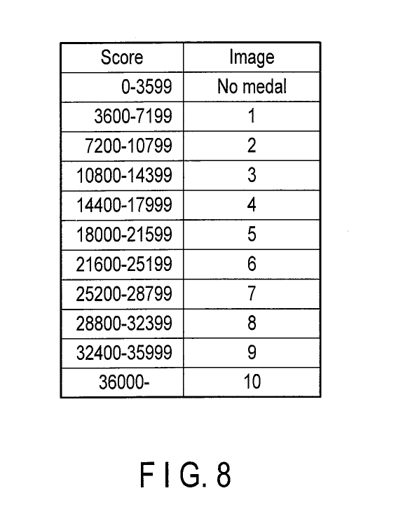

In FIG. 5, the number of medals, which are displayed in the metal display area 201D, increases as the total score increases. Ten medals at maximum can be displayed in the medal display area 201D, and no medal is displayed in the initial state. Each time display of a round of contribution degree images is completed (i.e. each time the contribution degree image of the tenth level transitions back to the contribution degree image of the first level), the number of medals increases by one. In this sense, the medal is an object indicating that the total score has reached the value at which display of a round of contribution degree images is completed. The number of medals corresponds to an evaluation value of the total score. FIG. 8 illustrates the relationship between the number of medals displayed and the total score.

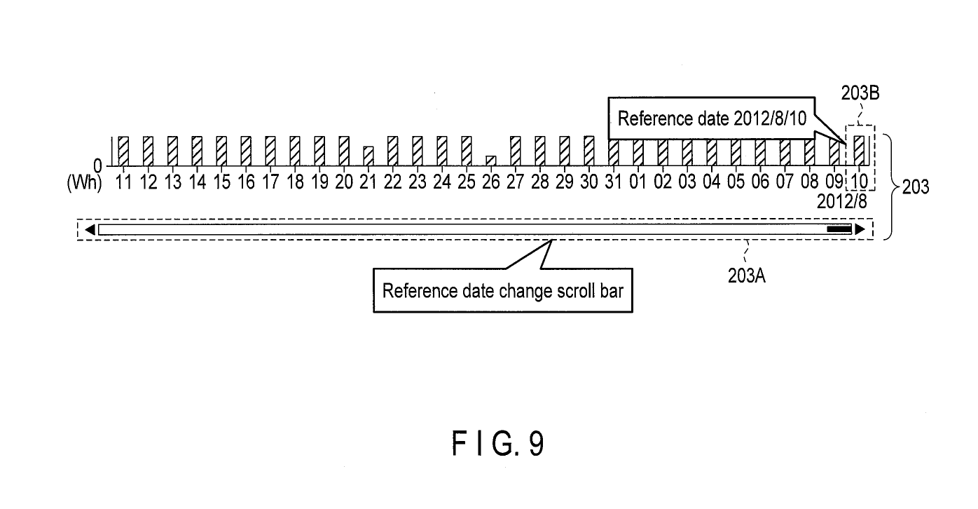

FIG. 9 illustrates the details of the reference date change area 203. The reference date change area 203 displays a reference date change slide bar 203A and a reference date 203B. Triangular jump buttons are disposed at the left and right of the reference date change slide bar 203A. In the state shown in FIG. 9, “Aug. 10, 2012” is designated as the reference date 203B. By moving the slider of the reference date change slide bar 203A or by pressing the jump button, the user can change the reference date to a past date or can bring the reference date back to the present date.

If the reference date is changed, the power-saving utility program 22 re-calculates the above-described total score. Specifically, the total score during the period from the score calculation start date to the changed reference date is newly calculated by the power-saving utility program 22. Based on the newly calculated total score, the power-saving utility program 22 also executes a process of updating the contribution degree image that is to be displayed, and a process of updating the number of medals that are to be displayed. Thereby, the user can easily visually compare the total score, contribution degree image and number of medals during the period from the score calculation start date to the present date with the total score, contribution degree image and number of medals during the period from the score calculation start date to the past reference date. Thus, the user can realize the history of contribution to power saving, while looking back on the past.

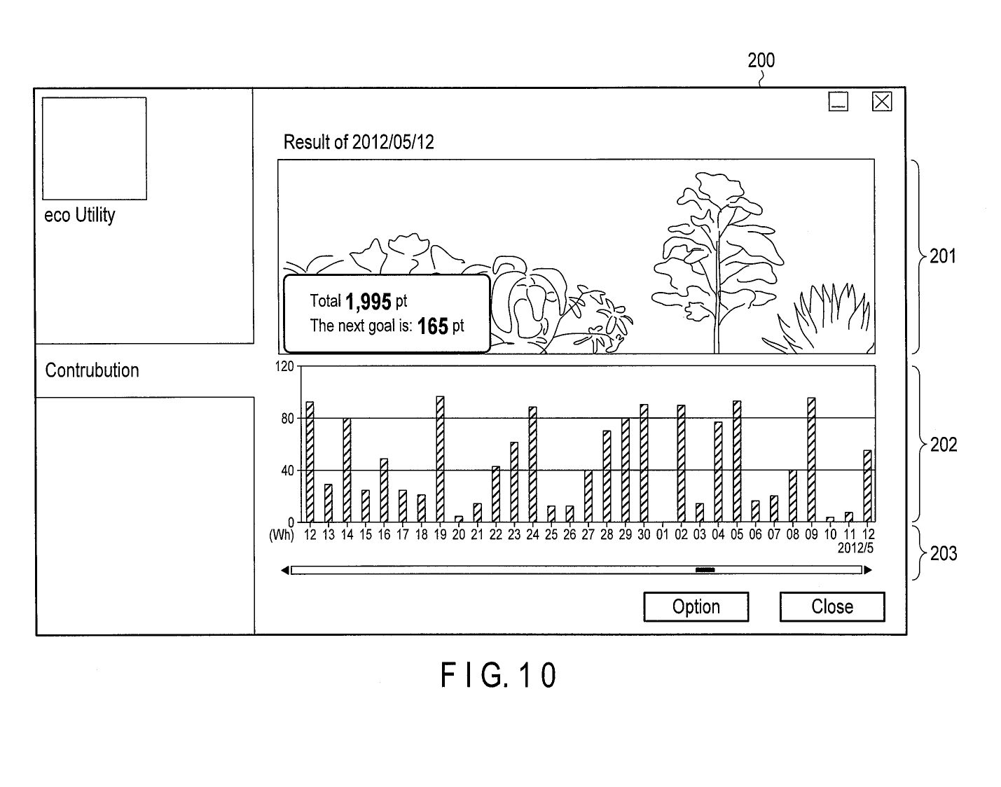

FIG. 10 illustrates the contribution degree screen 200 which is displayed when the reference date was changed from “Aug. 10, 2012” to “May 12, 2012”. The user can confirm that the contribution degree image, the score, etc. are different from those in FIG. 4.

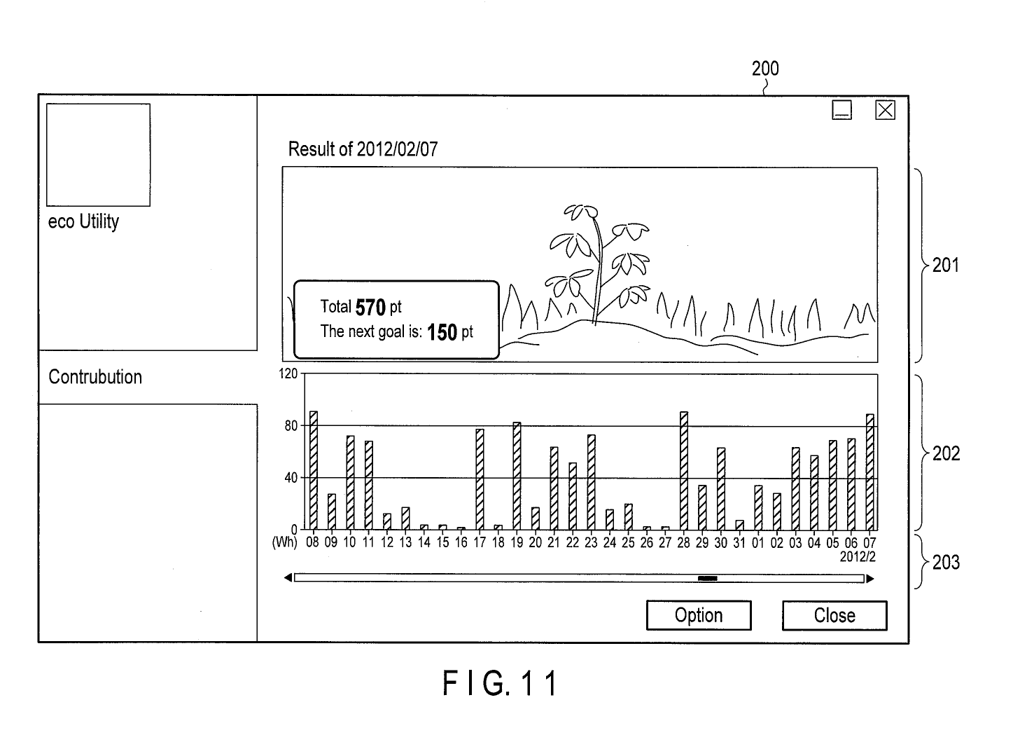

FIG. 11 illustrates the contribution degree screen 200 which is displayed when the reference date was further changed to “Feb. 7, 2012”. The user can confirm that the contribution degree image, the score, etc. are different from those in FIG. 4 and FIG. 10.

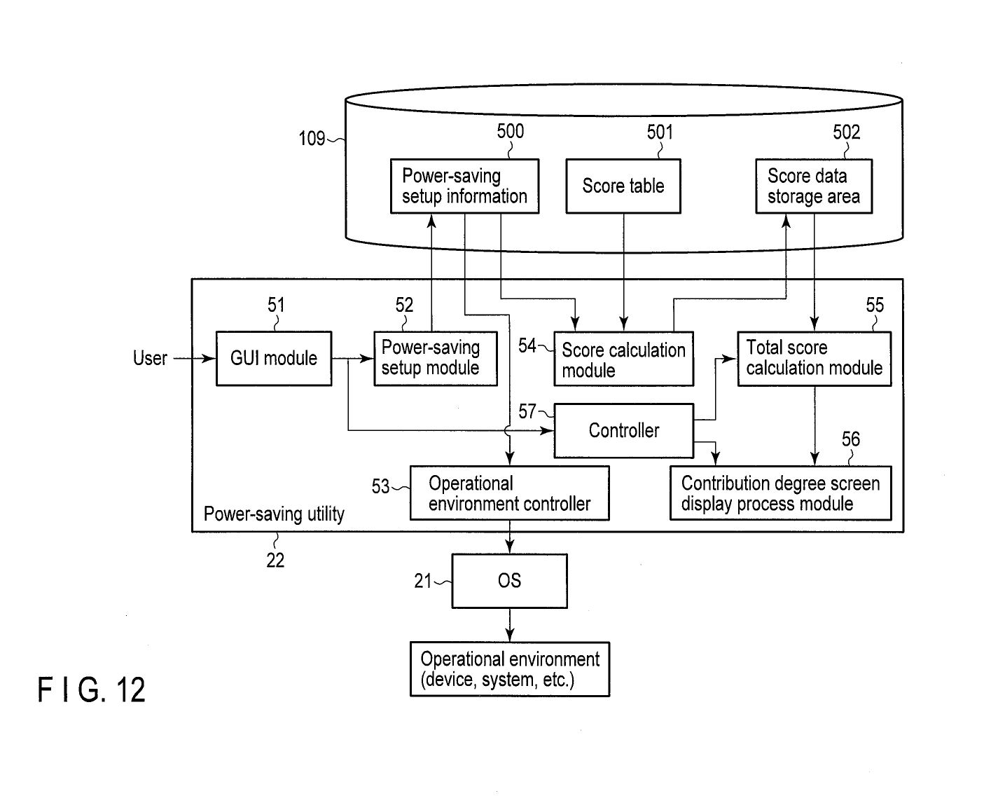

FIG. 12 illustrates the configuration of the power-saving utility program 22.

The power-saving utility program 22 includes, as function execution modules, a user interface (GUI) module 51, a power-saving setup module 52, an operational environment controller 53, a score calculation module 54, a total score calculation module 55, a contribution degree screen display process module 56, and a controller 57.

The user interface (GUI) module 51 displays on the display the power-saving setup screen 100 which has been described with reference to FIG. 3, or the contribution degree screen 200 which has been described with reference to FIG. 4, in accordance with a user operation. The power-saving setup module 52 sets, in accordance with a user operation, values which have been designated by the user, as the values of the respective power-saving setup items in power-saving setup information 500 which is stored in the HDD 109. The power-saving setup information 500 is information indicative of values corresponding to the many setup items described with reference to FIG. 3. The operational environment controller 53 sets the computer 10 in the power-saving state, based on the values (power-saving setup values) of the respective power-saving setup items in the power-saving setup information 500. The control of the operation (operational environment) of each device and system in the power-saving state is executed via the OS 21.

The score calculation module 54 and total score calculation module 55 function as a calculator configured to execute a process of calculating the above-described total score. The points of the total score (and the above-described day score) become higher in the case of power-saving setup for greater power saving, and the points of the total score become higher as the driving time of the computer 10 with the power-saving setup for greater power saving is longer. The minimum point of the score (day score), which is obtained in one day, is 0 pt, and the maximum points of the score (day score), which is obtained in one day, are 100 pt. The total score is the sum of the day scores obtained in the period from the score calculation start date to the present date. The total score is calculated by adding up the day scores. An example of the method of calculating the score is as follows.

Score corresponding to certain power-saving setup (setting score)

$$SettingScore = {\sum }_{i = 1}^{L} ( Score [ i ] \times Weight [ i ] ) \qquad ( 1 )$$

L: number of power-saving settings
Score[i]: score of power-saving setting i (Score[i] is defined in advance. The range of Score[i] is 0 to 100.
Score[i] takes a higher value for setting for greater power saving.)
Weight[i]: weight of power-saving setting i (defined in advance).

Average score of one day (day score)

$$DayScore = \frac{{\sum }_{j = 1}^{j} ( SettingScore [ j ] \times Time [ j ] )}{{\sum }_{j = 1}^{j} ( Time [ j ] )} \qquad ( 2 )$$

j: number of SettingScore[j] existing in one day
Time[j]: time of driving with certain setting j.

Aggregate score (total score)

$$TotalScore = {\sum }_{k = 1}^{K} ( DayScore [ k ] ) \qquad ( 3 )$$

K: number of days of PC driving (from score calculation start date to reference date).

The score calculation module 54 refers to a score table 501, and calculates the above-described setting score and day score. The score table 501 prestores the score corresponding to each power-saving setup value with respect to each of the plural power-saving setup items. The score calculation module 54 checks the present date and the present power-saving setup information, for example, each time the computer 10 is activated, and calculates the setting score. In addition, for example, each time the computer 10 is turned off, the score calculation module 54 calculates the above-described day score, and stores the calculated day score in a score data storage area 502 in the state in which the calculated day score is associated with the present date. Furthermore, for example, also in the case where the present power-saving setup state has been changed or the date has been changed, the score calculation module 54 calculates the above-described day score, and stores the calculated day score in the score data storage area 502 in the state in which the calculated day score is associated with the present date. The total score calculation module 55 calculate the above-described total score by totaling the day scores corresponding to all days belonging to the period from the score calculation start date to the reference date.

The contribution degree screen display process module 56 functions a display processor configured to display the contribution degree screen 200 which has been described with reference to FIG. 4, based on the total score obtained by the total score calculation module 55. The controller 57 changes the reference date in accordance with an operation of the reference date change area 203 by the user. The changed reference date is sent to the total score calculation module 55. The total score calculation module 55 re-calculates the total score based on the changed reference date. In accordance with the re-calculated total score, the contribution degree screen display process module 56 updates the total score, the contribution degree image and the number of medals on the contribution degree screen 200.

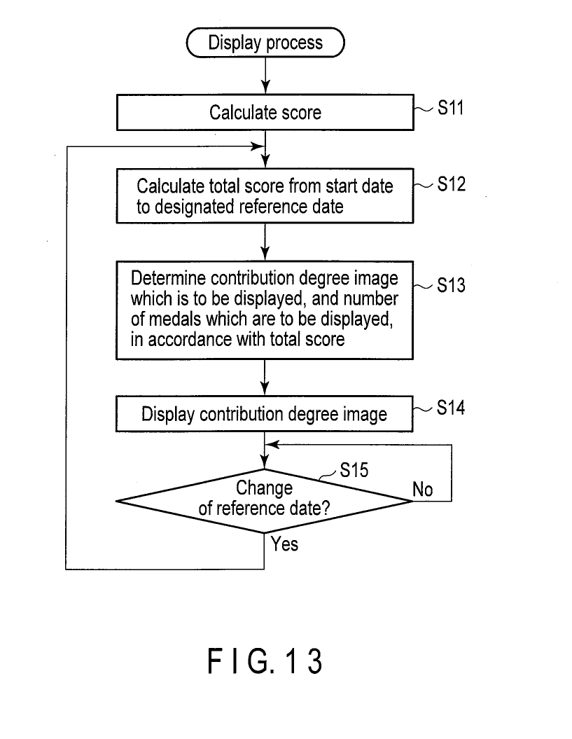

FIG. 13 illustrates the procedure of a process of displaying the contribution degree screen 200.

The power-saving utility program 22 calculates, on a day-by-day basis, a score (day score) indicating a degree by which the power-saving state of the computer 10 has contributed to power saving in each day, and stores the calculated score in the score data storage area 502 (step S11). Then, the power-saving utility program 22 totals a plurality of scores corresponding to a plurality of days belonging to the period from the score calculation start date to the reference date, thereby calculating the total score indicative of a degree by which the power-saving state of the computer 10 has contributed to power saving during the period from the score calculation start time point to the reference time point (step S12).

Based on the total score, the power-saving utility program 22 determines the contribution degree image which is to be displayed, and the number of medals which are to be displayed (step S13). The power-saving utility program 22 advances to step S14, and displays the contribution degree screen 200 which has been described with reference to FIG. 4 (step S14).

During the period in which the contribution degree screen 200 is being displayed, the power-saving utility program 22 determines whether an operation of changing the reference date has been executed or not (step S15). If the reference date has been changed (YES in step S15), the power-saving utility program 22 re-calculates the total score (step S12). In the process of re-calculating the total score, the power-saving utility program 22 totals plural day scores corresponding to plural days belonging to the period from the score calculation start date to the changed reference date. Then, based on the re-calculated total score, the power-saving utility program 22 determines the contribution degree image which is to be displayed, and the number of medals which are to be displayed (step S13) and displays the contribution degree screen 200 (step S14).

As has been described above, according to the present embodiment, not the score corresponding to a certain instantaneous power-saving setup, but the total score, which indicates the degree by which the power-saving state of the computer 10 has contributed to power saving during the time period from the score calculation start time point to the reference time point, is calculated, and the image (contribution degree image) which is associated with the total score is displayed. Thus, the degree of contribution to power saving, which is accumulated on a day-by-day basis by using the computer 10 in the power-saving state, can be easily understandably presented to the user, and it is possible to promote continuous use of the power-saving state by the user.

In addition, since the reference date can be changed, the user can realize the history of contribution to power saving, by visually comparing the contribution degree image corresponding to the total score during the period from the score calculation start date to the present date with the contribution degree image corresponding to the period from the score calculation start date to the past reference date.

In the present embodiment, the description has been given of the example in which the total score is calculated by totaling a plurality of scores which are calculated on a day-by-day basis. The embodiment is not limited to this example, and the total score may be calculated by totaling scores which are calculated in units of a predetermined period. In this case, the total score can be calculated by totaling a plurality of scores corresponding to a plurality of unit periods belonging to the period from the score calculation start time point to the reference time point.

In the present embodiment, an average score in a day is calculated as a day score. Instead of using the average score, the value obtained by the numerator of equation (2) may be used as the day score.

In the present embodiment, some specific power-saving setup items have been illustrated as the power-saving setup items which are used for the calculation of the total score. However, the number of power-saving setup items, which are used for the calculation of the total score, may be one.

All the procedures of the power-saving setup process and contribution degree screen display process of the embodiment can be executed by software. Thus, the same advantageous effects as with the present embodiment can easily be obtained simply by installing a computer program, which executes these procedures, into an ordinary computer through a computer-readable storage medium which stores the computer program, and executing the computer program. In addition, the functions of the respective components shown in FIG. 12 may be realized by hardware such as a purpose-specific LSI or a DSP.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an operation controller configured to set the information processing apparatus in a power-saving state, based on a power-saving setup value corresponding to at least one power-saving setup item, wherein the power-saving setup value is user-determined;
a calculator configured to calculate a total score indicative of a degree by which the power-saving state contributes to power saving during a period from a score calculation start time point to a reference time point; and
a display processor configured to display an image which is associated with the total score.

2. The information processing apparatus of claim 1, wherein the display processor is configured to display the total score and the image which is associated with the total score.

3. The information processing apparatus of claim 1, further comprising a change module configured to change the reference time point to a temporally past time point,
wherein the calculator is further configured to re-calculate the total score if the reference time point is changed.

4. The information processing apparatus of claim 1, wherein the score calculation start time point is indicative of a score calculation start date, and wherein the reference time point is indicative of a present date.

5. The information processing apparatus of claim 4, further comprising a change module configured to change the reference time point to a past date preceding the present date,
wherein the calculator is further configured to re-calculate the total score if the reference time point is changed to the past date.

6. The information processing apparatus of claim 1, wherein the calculator is configured to calculate the total score by totaling a plurality of scores corresponding to a plurality of unit periods belong to the period from the score calculation start time point to the reference time point, each of the plurality of scores indicative of a degree by which the power-saving state contributes to the power saving during the unit period.

7. The information processing apparatus of claim 1, wherein the display processor is further configured to change the image which is to be displayed if the total score reaches any one of a plurality of thresholds, and to display a residual score which remains before the total score reaches a next threshold which is closest to the total score.

8. The information processing apparatus of claim 1, wherein the display processor is further configured to change the image which is to be displayed, among a plurality of images with different degrees of growth of a plant, such that an image, by which growth of the plant is more perceivable as the total score becomes higher, is displayed.

9. An information processing method comprising:
setting an information processing apparatus in a power-saving state, based on a power-saving setup value corresponding to at least one power-saving setup item, wherein the power-saving setup value is user-determined;
calculating a total score indicative of a degree by which the power-saving state contributes to power saving during a period from a score calculation start time point to a reference time point; and
displaying an image which is associated with the total score.

10. A computer-readable, non-transitory storage medium comprising a program configured to be executed by a computer, the program controlling the computer to execute functions of:
setting the computer in a power-saving state, based on a power-saving setup value corresponding to at least one power-saving setup item, wherein the power-saving setup value is user-determined;
calculating a total score indicative of a degree by which the power-saving state contributes to power saving during a period from a score calculation start time point to a reference time point; and
displaying an image which is associated with the total score.
